(19) United States
(12) Patent Application Publication
(10) Pub. No.: US 2025/0124455 A1
(43) Pub. Date: Apr. 17, 2025

(54) CUSTOMER ISSUE TROUBLESHOOTING

(71) Applicant: T-MOBILE INNOVATIONS LLC, Overland Park, KS (US)

(72) Inventors: Ariz JACINTO, Bellevue, WA (US); Mana MEHRAEIN, Seattle, WA (US); Sangwoo HAN, Bellevue, WA (US); Prem Kumar BODIGA, Bothell, WA (US); Hermie Agustin PADUA, Marysville, WA (US); Jacob Alexander LEIGHTY, Seattle, WA (US); Wei HUANG, Bellevue, WA (US)

(21) Appl. No.: 18/380,983

(22) Filed: Oct. 17, 2023

(51) Int. Cl. G06Q 30/015; G06F 3/04847

(52) U.S. Cl. CPC G06Q 30/015; G06F 3/04847

(57) ABSTRACT

Methods and computer-readable media for providing customer issue troubleshooting are provided. Customer service representatives may use the graphical user interface (GUI) to more effectively diagnose issues subscribers may be experiencing with the network service. The GUI provides a window containing diagnostic segments displayed on a computer screen. The window is monitored to detect a selection of a diagnostic segment. The diagnostic segments provide categories of possible network service issues and include: a coverage segment, a voice segment, a data segment, and a device segment. Once a diagnostic segment has been selected the window automatically displays the diagnostic result. In addition, information on a network service degradation event may be displayed on an event timeline segment of the window. The window also provides segments for customer information, recommendations to the customer, and a slider allowing adjusting of a date timeline for network service disruptions.

### BACKGROUND

Network subscribers may visit a network operator's retail store or call a customer support center to complain about network coverage issues. Many customer service representatives lack technical expertise to determine if the customer's issue is a device problem, a service issue, or a problem with an application. The customer service representative attempts to direct the network subscriber to the appropriate technical team, but often do not succeed, resulting in multiple transfers to different technical teams. Understandably, network subscribers become frustrated by the frequent misdiagnoses and wasted time. Tools to assist customer service representatives diagnose customer service issues and recommend appropriate corrective action have not been available.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

According to aspects herein, methods and systems for providing customer issue troubleshooting are provided. Customer service representatives may use the graphical user interface (GUI) described in detail below to more effectively diagnose issues subscribers may be experiencing with the network service. The GUI provides a window containing diagnostic segments in a format and is displayed on a computer screen. The window is monitored to detect a selection of a diagnostic segment. The diagnostic segments provide categories of possible network service issues and include: a coverage segment, a voice segment, a data segment, and a device segment. Once the diagnostic segment has been selected the window automatically displays at least one diagnostic result. In addition, information on a network service degradation event may be displayed on an event timeline segment of the window. The window also provides segments for customer information, recommendations to the customer, and a slider allowing adjusting of a date timeline for network service disruptions.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a cellular network suitable for use in implementations of the present disclosure, in accordance with aspects herein;

FIG. 3 depicts a graphical user interface for improved customer issue troubleshooting, in accordance with aspects herein;

FIG. 4 depicts a flow diagram of an exemplary method for customer issue troubleshooting, in accordance with aspects herein; and

FIG. 5 depicts an exemplary computing device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure.

Customer service representatives face the challenge of correctly ascertaining which of multiple categories correctly identify a network subscriber's service issue. The customer may have difficulty in one or more categories, such as coverage, voice, data, and device. Coverage issues may include low coverage, lack of coverage, domestic roaming, international roaming, and coverage at home. Voice issues may include calls being dropped by multiple network technologies such as 5G, 4G, and VoLTE, or WiFi calls being dropped. Data issues may include data delay, domain name system (DNS) impairment, and leakage. Device issues may include device compatibility with the network, device and access point band compatibility, and software issues. Each of these areas may utilize key performance indicators (KPIs) to measure and check network and device performance.

A system, method, and apparatus for customer issue troubleshooting may include a graphical user interface (GUI) to assist customer service representatives in diagnosing customer service issues. The customer issue troubleshooting GUI allows a customer service representative to assess a customer's service issue in the four areas of coverage, voice, data, and device. The customer issue troubleshooting GUI interacts with software that provides real-time analysis that incorporate machine learning and also interacts with multiple diagnostic tests to isolate the issue. The GUI provides information on the KPIs for each of the four areas along with active links to provide further information. As an example, if there is a cell site associated with service degradation and it appears that the customer is in the affected area, a tower icon allows the service representative to view a map linked with the service degradation. The linked map also provides further information about the site, such as dates and update information for the cell site in question. The customer issue troubleshooting GUI also provides an event timeline for each KPI degradation event along with additional details. A recommendation section is based on the results from the diagnostics section and offers reasons why the network problem occurred. In addition, a slider is available for varying the timeframe displayed. Each event may be highlighted on the event timeline. Customer network issues may be linked to network changes or modifications. The customer issue troubleshooting GUI links the customer's issue to network changes and device issues, with each recommendation customized to a particular technical team. The recommendations may include software updates, network improvement roll-out information, device upgrades, or suggestions to improve network experience.

Further, various technical terms are used throughout this description. An illustrative resource that fleshes out various aspects of these terms can be found in Newton's Telecom Dictionary, 32^{nd} Edition (2022).

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of access points (i.e., access point, node, cell sites, cell towers) to provide network coverage. The access points are employed to broadcast and transmit transmissions to user devices of the telecommunications network. An access point may be considered to be a portion of an access point that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, an access point may comprise one access point or more than one access point. Factors that can affect the telecommunications transmission include, e.g., location and size of the access points, and frequency of the transmission, among other factors. The access points are employed to broadcast and transmit transmissions to user devices of the telecommunications network. Traditionally, the access point establishes uplink (or downlink) transmission with a mobile handset over a single frequency that is exclusive to that particular uplink connection (e.g., an LTE connection with an EnodeB). The access point may include one or more sectors served by individual transmitting/receiving components associated with the access point (e.g., antenna arrays controlled by an EnodeB). These transmitting/receiving components together form a multi-sector broadcast arc for communication with mobile handsets linked to the access point.

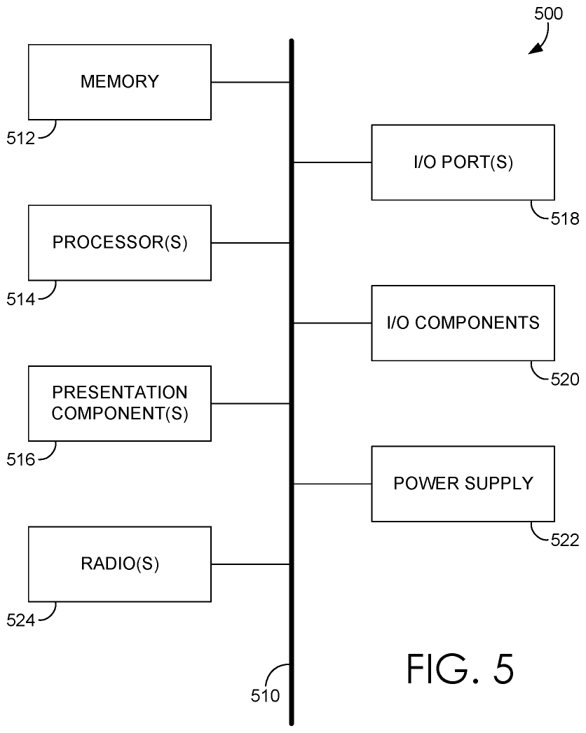

As used herein, “access point” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE). The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network. A UE, as one of ordinary skill in the art may appreciate, generally includes one or more antennas coupled to a radio for exchanging (e.g., transmitting and receiving) transmissions with a nearby access point. A UE may be, in an embodiment, similar to device 500 described herein with respect to FIG. 5.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby access point or access point.

In aspects, a UE provides UE data including location and channel quality information to the wireless communication network via the access point. Location information may be based on a current or last known position utilizing GPS or other satellite location services, terrestrial triangulation, an access point's physical location, or any other means of obtaining coarse or fine location information. Channel quality information may indicate a realized uplink and/or downlink transmission data rate, observed signal-to-interference-plus-noise ratio (SINR), reference signal received quality (RSRQ), and/or signal strength at the user device, or throughput of the connection. Channel quality information may be provided via, for example, an uplink pilot time slot, downlink pilot time slot, sounding reference signal, channel quality indicator (CQI), rank indicator, precoding matrix indicator, or some combination thereof. Channel quality information may be determined to be satisfactory or unsatisfactory, for example, based on exceeding or being less than a threshold. Location and channel quality information may take into account the user device capability, such as the number of antennas and the type of receiver used for detection. Processing of location and channel quality information may be done locally, at the access point or at the individual antenna array of the access point. In other aspects, the processing of said information may be done remotely.

A first aspect of the present disclosure provides a method for customer issue troubleshooting. The computer-implemented method begins with displaying a window containing diagnostic segments in a format within a GUI on a computer screen. The window is then monitored to detect a selection of at least one diagnostic segment. After selection of at least one diagnostic segment at least one diagnostic result is displayed for the at least one diagnostic segment. In addition, an event timeline window segment automatically displays information on a network service degradation event.

A second aspect of the present disclosure provides a computer-implemented method of troubleshooting customer issues in a network. The method begins with displaying a window containing diagnostic segments in a format within a graphical user interface on a computer screen. Next, the method continues with monitoring the window to detect a selection of at least one diagnostic segment. The GUI then automatically displays at least one diagnostic result for the selected at least one diagnostic segment. The method concludes with automatically displaying at least one recommendation or explanation in a recommendation segment of the window.

Another aspect of the present disclosure is directed to a non-transitory computer storage media storing computer-usable instructions that cause the processors to display a window containing diagnostic segments in a format within a GUI on a computer screen. The instructions also direct that the window be monitored to detect a selection of at least one diagnostic segment. The processors then instruct the automatic display of at least one diagnostic result for the selected at least one diagnostic segment. The instructions concludes with instructions to display automatically on an event timeline window segment information on a network service degradation event.

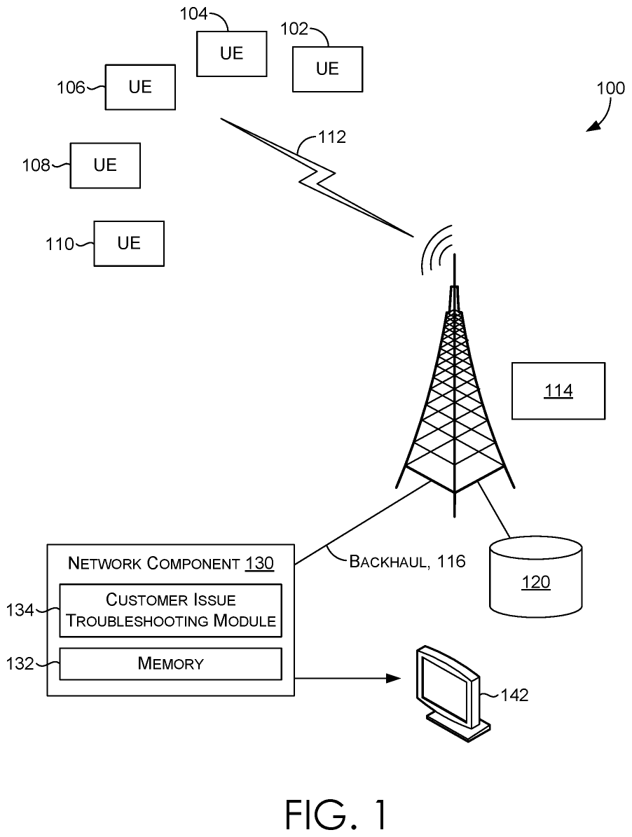

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

Network environment 100 includes user devices (UE) 102, 104, 106, 108, and 110, access point 114 (which may be a cell site, access point, or the like), and one or more communication channels 112. The communication channels 112 can communicate over frequency bands assigned to the carrier. In network environment 100, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device 500) that communicates via wireless communications with the access point 114 in order to interact with a public or private network.

In some aspects, each of the UEs 102, 104, 106, 108, and 110 may correspond to computing device 500 in FIG. 5. Thus, a UE can include, for example, a display(s), a power source(s) (e.g., a battery), a data store(s), a speaker(s), memory, a buffer(s), a radio(s) and the like. In some implementations, for example, a UEs 102, 104, 106, 108, and 110 comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, 6G, LTE, CDMA, or any other type of network. In some cases, UEs 102, 104, 106, 108, and 110 in network environment 100 can optionally utilize one or more communication channels 112 to communicate with other computing devices (e.g., a mobile device(s), a server(s), a personal computer(s), etc.) through access point 114.

The network environment 100 may be comprised of a telecommunications network(s), or a portion thereof. A telecommunications network might include an array of devices or components (e.g., one or more access points), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure. Network environment 100 may comprise equipment placed in network operator facilities, but may also comprise equipment located at a customer's premises, known as customer premises equipment (CPE).

The one or more communication channels 112 can be part of a telecommunication network that connects subscribers to their immediate telecommunications service provider (i.e., home network carrier). In some instances, the one or more communication channels 112 can be associated with a telecommunications provider that provides services (e.g., 3G network, 4G network, LTE network, 5G network, 6G, and the like) to user devices, such as UEs 102, 104, 106, 108, and 110. For example, the one or more communication channels may provide voice, SMS, and/or data services to UEs 102, 104, 106, 108, and 110, or corresponding users that are registered or subscribed to utilize the services provided by the telecommunications service provider. The one or more communication channels 112 can comprise, for example, a 1× circuit voice, a 3G network (e.g., CDMA, CDMA2000, WCDMA, GSM, UMTS), a 4G network (WiMAX, LTE, HSDPA), or a 5G network or a 6G network. The telecommunication network may also provide services using MU-MIMO techniques.

In some implementations, access point 114 is configured to communicate with a UE, such as UEs 102, 104, 106, 108, and 110, that are located within the geographic area, or cell, covered by radio antennas of access point 114. Access point 114 may include one or more access points, base transmitter stations, radios, antennas, antenna arrays, power amplifiers, transmitters/receivers, digital signal processors, control electronics, GPS equipment, and the like.

As shown, access point 114 is in communication with a network component 130 and at least a network database 120 via a backhaul channel 116. As the UEs 102, 104, 106, 108, and 110 collect individual signal information, the signal information can be automatically communicated by each of the UEs 102, 104, 106, 108, and 110 to the access point 114. Access point 114 may store the signal information and data communicated by the UEs 102, 104, 106, 108, and 110 at a network database 120. Alternatively, the access point 114 may automatically retrieve the status data from the UEs 102, 104, 106, 108, and 110, and similarly store the data in the network database 120. The signal information and data may be communicated or retrieved and stored periodically within a predetermined time interval which may be in seconds, minutes, hours, days, months, years, and the like. With the incoming of new data, the network database 120 may be refreshed with the new data every time, or within a predetermined time threshold so as to keep the status data stored in the network database 120 current. For example, the data may be received at or retrieved by the access point 114 every 10 minutes and the data stored at the network database 120 may be kept current for 30 days, which means that status data that is older than 30 days would be replaced by newer status data at 10 minute intervals. As described above, the status data collected by the UEs 102, 104, 106, 108, and 110 can include, for example, service state status, the respective UE's current geographic location, a current time, a strength of the wireless signal, available networks, and the like. The status data may be used to diagnose network issues experienced by network subscribers and may also be used to measure service improvements.

The network component 130 comprises a memory 132, a customer issue troubleshooting module 134. All determinations, calculations, and data further gathered by the customer issue troubleshooting module 134 may be stored at the memory 132 and also at the data store 140. Although the network component 130 is shown as a single component comprising the memory 132, customer issue troubleshooting module 134, and the data store 140, it is also contemplated that each of the memory 132, the customer issue troubleshooting module 134 may reside at different locations, be its own separate entity, and the like, within the home network carrier system. Computer terminal 142 communicates with network component 130 and through network component 130 with memory 132 and customer issue troubleshooting module 134.

The network component 130 is configured to retrieve network data on an access point as well as signal quality metrics and carrier loading metrics from the access point 114 or one of the UEs, 102, 104, 106, 108, and 110. Signal quality metrics can include any one or more of multiple metrics, such as signal-to-interference plus noise ratio (SINR), reference signal received power (RSRP), and reference signal received quality (RSRQ). The network component 130 can also track uplink and downlink user traffic. In addition, the status of proposed network improvements may also be provided, such as antenna upgrades to improve coverage area. The customer issue troubleshooting module 134 and URA may be located in a central office or other centralized location.

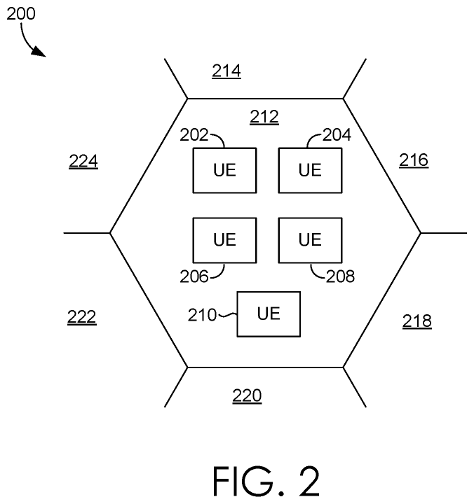

FIG. 2 depicts a cellular network suitable for use in implementations of the present disclosure, in accordance with aspects herein. For example, as shown in FIG. 2, each geographic area in the plurality of geographic areas may have a hexagonal shape such as hexagon representing a geographic area 200 having cell sites 212, 214, 216, 218, 220, 222, 224, each including access point 114, backhaul channel 116, antenna for sending and receiving signals over communication channels 112, network database 120 and network component 130.

The size of the geographic area 200 may be predetermined based on a level of granularity, detail, and/or accuracy desired for the determinations/calculations done by the systems, computerized methods, and computer-storage media. A plurality of UEs may be located within each geographic area collecting UE data within the geographic area at a given time. For example, as shown in FIG. 2, UEs 202, 204, 206, 208, and 210, may be located within geographic area 200 collecting UE data that is useable by network component 130, in accordance with aspects herein. UEs 202, 204, 206, 208, and 210 can move within the cell currently occupying, such as cell site 212 and can move to other cells such as adjoining cell sites 214, 216, 218, 220, 222 and 224. Data on the performance on the access points in cell sites 212, 214, 216, 218, 220, 222, and 224 may also be collected.

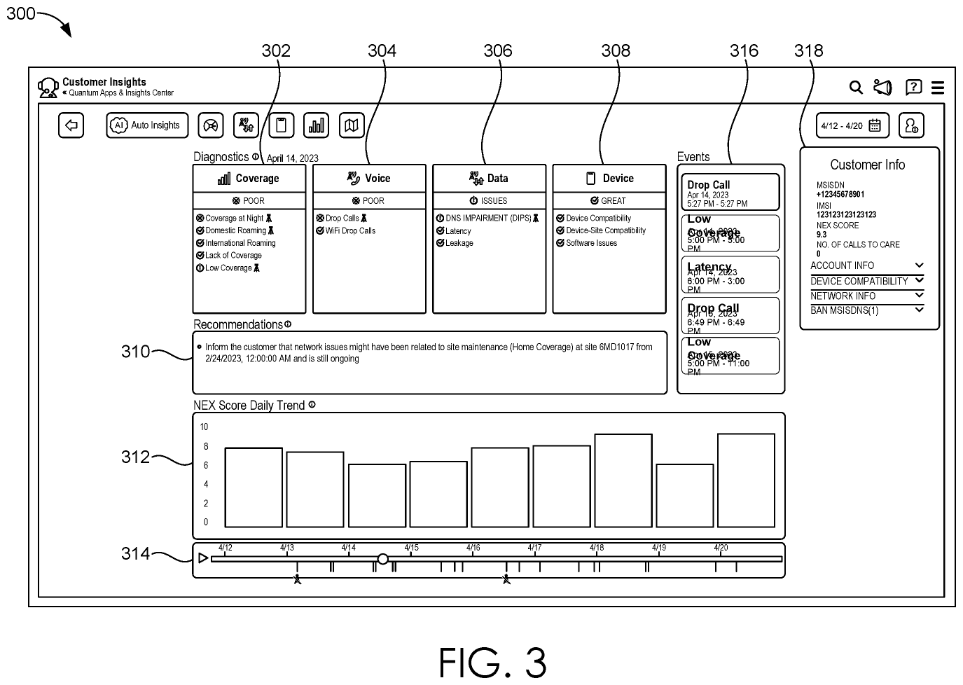

FIG. 3 depicts a graphical user interface for improved customer issue troubleshooting, in accordance with aspects herein. The GUI 300 provides customer service representatives with a tool for customer issue troubleshooting. The GUI 300 provides diagnostic recommendations for four areas of potential customer issues through multiple selectable segments: coverage segment 302, voice segment 304, data segment 306, and device segment 308. The coverage segment 302 provides troubleshooting guidance for coverage at night, band compatibility, low coverage, lack of coverage, and roaming, both domestic and international.

Coverage considers the coverage experience taken at a sample time of between 1 AM to 5 AM. If the coverage sample reports less than −115 dBM, the coverage may be considered poor. If this result is obtained then the customer issue troubleshooting module may cause the GUI 300 to display different root cause analysis checks to be performed. One root cause analysis check may direct the customer service representative to check for a site related issue. Site related issues may include site maintenance, site outage, or other site-related issues. The customer may then be informed that the service issue was due to a site event and additional information about updates to the site, maintenance, as well as a date for site service to be completed.

In some cases, a customer's coverage issue may be causes by a merger between cellular service providers with customers required to move their cellular service to the senior provider in the merger. In such situations the customer service representative may receive a message on the GUI 300 that “this legacy customer needs to be evaluated for network migration” or similar message. If the customer is not a legacy customer, a further check may be performed to ascertain if the customer is making a WiFi call. The GUI 300 may display a recommendation to the customer service representative to inform the customer that switching to WiFi may improve their service if the WiFi connection at their home location is available.

Band capability may also cause customer coverage issues for customer service representatives. The customer issue troubleshooting module may suggest that a check be performed to see if the customer's UE or other device and the access point dominantly connected to have band compatibility. This may occur if the access point dominantly connected to supports 5G service but the UE being used is only a LTE device. In this case, the customer issue troubleshooting module may output a message to the GUI 300 “Suggest to customer that they upgrade to a 5G device in order to properly enjoy 5G speeds at home and on the go”. The reverse situation may also occur, with the customer having a 5G device but the access point has not yet been upgraded to 5G service. The GUI may then advise the customer service representative to let the customer know when 5G service will be available on the access point in question.

Low coverage may also cause customer service issues. A check may be made to determine if the customer has experienced any low coverage events. If low coverage events are detected, the offending sector of the access point will be checked for site events. It may be that the sector has had antenna issues or routine maintenance is being performed. The customer service representative may inform the customer of when the site event occurred and when it may be resolved. Lack of coverage events may be handled similarly to low coverage events. In both cases, a recommendation to enable WiFi calling on their device may be suggested to the customer service representative to pass along to the customer.

A further coverage issue may be domestic roaming. Domestic roaming occurs when a network customer is temporarily connected to another network, which may occur when the customer is in an area where their network service provider does not have coverage. When this occurs, the UE may not automatically connect back to the usual network service provider. A check may be made to determine if the customer has been on domestic roaming. In such cases the GUI may display a recommendation to advise the customer that the UE is roaming to another network and may experience issues such as slow network speeds, dropped calls, or similar service disruptions. The recommendation may further advise toggling the UE's airplane mode on/off to switch back to the network service provider network.

The voice segment 304 is used in determining if a network subscriber's issue is related to voice service. A check is made to determine if the network subscriber has had dropped calls. If a dropped call event is detected, the sector of an access point in the network that was used during the dropped call is examined. The examination may look for maintenance events or other site events, such as breakdowns or upgrades. The customer may be informed that the performance degradation was due to an access point event that has been or will be corrected. If the dropped call was caused by a coverage issue, the customer may be informed of the correlation. The voice segment 304 may also check for dropped WiFi calls.

The data segment 306 is used in determining if the network subscriber's issues are related to data network service. A check may be made to determine if the network subscriber has experienced any latency. If a delay event is detected, the access point sector used during the delay event will be checked to see if the performance degradation was due to an access point event. If so, the network subscriber may be informed of the corrective actions being taken and also provided with a date for resolution of the service issues.

The data segment 306 may also be used in determining if the network subscriber's issue is related to data leakage. Data leakage may occur during an access point event, and if this is the case, the network subscriber will be informed about the key performance indicators affected and a date range for the data leakage event at the access point.

In addition, the data segment 306 may also advise a customer service representative about domain name system impairment (DIPS) that may occur. A DIPS event may occur when a browser cannot convert a domain name to an IP address. The customer service representative checks to see if the network subscriber experienced a DIPS event. The network subscriber may be advised that the DIPS event may be caused by an access point event, and may also be informed of possible resolution date and time.

The device segment 308 allows a customer service representative to perform multiple device checks. A first device check may determine if the network subscriber's device is compatible with the network. A device may be old enough that it does not support 5G, mid-band or low-band frequencies and as a result is not compatible or provides a poor user experience. The customer service representative may advise the network subscriber to upgrade their device to obtain low-band frequencies. A second device check may determine if the software version currently installed on the network subscriber's device shows any degradation in the network. If issues are detected, the network subscriber may be advised to update their device with the latest software version and also to advise backing up data and voicemail prior to performing the update. If the network subscriber is using the latest software available, they may be advised that a software issue exists and that the network operator is already working with the device manufacturer to implement a solution. In this scenario, it is likely that the issue has already been communicated to the appropriate technical team.

FIG. 3 provides a recommendations segment 310 where each of the specific recommendations provided by the diagnostic segments are presented in the customer issue troubleshooting GUI 300. A network experience (NEX) daily trend segment 312 shows the NEX score for the network subscriber for a selected period. At the bottom of the GUI 300 a slider displays the date range selected for troubleshooting. All the events are displayed in chronological order and by reviewing each date, all of the diagnostics and recommendations are updated based on the selected date. An events segment 316 displays an event timeline and provides date and hour indication of key performance indicator degradation for the network subscriber. This events segment 316 may also assist in determining correlations between events in the event timeline. A customer information segment 318 provides customer information, including billing account information.

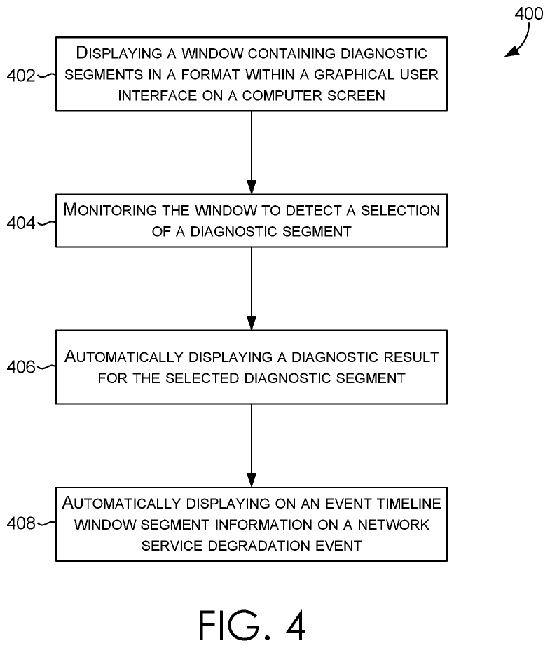

FIG. 4 depicts a flow diagram of an exemplary method for customer issue troubleshooting, in accordance with aspects herein. The computer-implemented method 400 begins in step 402 with displaying a window containing diagnostic segments in a format within a GUI on a computer screen. The method continues with step 404 with monitoring the window to detect a selection of at least one diagnostic segment. Next, the method continues with step 406 automatically displaying at least one diagnostic result for the selected at least one diagnostic segment. The method concludes in step 408 with automatically displaying on an event timeline window segment information on a network service degradation event.

The GUI window may also include a recommendation segment that provides customer service representatives with corrective information on their network service issue. In addition, the window may also include a network experience score daily trend segment, which may depict changes in the calling customer's network experience for a selected period of time.

The selection period of time may be adjusted using the slider. A customer information segment also provides the customer service representative with a customer information segment that provides information on a customer's account, location, access point used at time of contact, and similar information. The GUI may also provide hourly granularity for a degradation event in the event timeline window.

The GUI also provides diagnostic segments that allow a customer service representative to select from potential sources of the customer's problem. The diagnostic segments may comprise: a coverage segment, a voice segment, a data segment, and a device segment. Each of the diagnostic segments provides diagnostic results for the selected diagnostic segment. The coverage segment may display diagnostic results for coverage, band compatibility, low coverage, lack of coverage, and roaming, both domestic and international.

The voice segment displays diagnostic results for dropped call issues with multiple network technologies, such as 5G, 4G, and VoLTE, and WiFi dropped calls. The data segment displays diagnostic results for delay, leakage, and domain name system impairment. The device segment displays diagnostic results for device compatibility and device software.

FIG. 5 depicts an exemplary computing device suitable for use in implementations of the present disclosure, in accordance with aspects herein. With continued reference to FIG. 5, computing device 500 includes bus 510 that directly or indirectly couples the following devices: memory 512, one or more processors 514, one or more presentation components 516, input/output (I/O) ports 518, I/O components 520, radio(s) 524, and power supply 522. Bus 510 represents what may be one or more busses (such as an address bus, data bus, or combination thereof). Although the devices of FIG. 5 are shown with lines for the sake of clarity, in reality, delineating various components is not so clear, and metaphorically, the lines would more accurately be grey and fuzzy. For example, one may consider a presentation component such as a display device to be one of I/O components 520. Also, processors, such as one or more processors 514, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 5 and refer to “computer” or “computing device.”

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 512 includes computer-storage media in the form of volatile and/or nonvolatile memory. Memory 512 may be removable, nonremovable, or a combination thereof. Exemplary memory includes solid-state memory, hard drives, optical-disc drives, etc. Computing device 500 includes one or more processors 606 that read data from various entities such as bus 510, memory 512 or I/O components 520. One or more presentation components 516 present data indications to a person or other device. Exemplary one or more presentation components 516 include a display device, speaker, printing component, vibrating component, etc. I/O ports 518 allow computing device 500 to be logically coupled to other devices including I/O components 520, some of which may be built into computing device 500. Illustrative I/O components 520 include a microphone, joystick, game pad, satellite dish, scanner, printer, wireless device, etc.

The radio(s) 524 represents one or more radios that facilitate communication with a wireless telecommunications network. While a single radio 524 is shown in FIG. 5, it is contemplated that there may be more than one radio 524 coupled to the bus 510. Illustrative wireless telecommunications technologies include CDMA, GPRS, TDMA, GSM, and the like. The radio 524 may additionally or alternatively facilitate other types of wireless communications including Wi-Fi, WiMAX, LTE, 3G, 4G, LTE, 5G, NR, VoLTE, or other VoIP communications. As can be appreciated, in various embodiments, radio 524 can be configured to support multiple technologies and/or multiple radios can be utilized to support multiple technologies. A wireless telecommunications network might include an array of devices, which are not shown so as to not obscure more relevant aspects of the invention. Components such as a access point, a communications tower, or even access points (as well as other components) can provide wireless connectivity in some embodiments.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A computer-implemented method for customer issue troubleshooting in a network, the method comprising:
displaying a window containing diagnostic segments in a format within a graphical user interface on a computer screen;
monitoring the window to detect a selection of a diagnostic segment;
automatically displaying a diagnostic result for the selected diagnostic segment; and
automatically displaying on an event timeline window segment information on a network service degradation event.

2. The method of claim 1, wherein the window comprises a recommendation segment.

3. The method of claim 1, wherein the window comprises a network experience score daily trend segment.

4. The method of claim 1, wherein the window comprises a customer information segment.

5. The method of claim 1, wherein the diagnostic segment is selected from: a coverage segment, a voice segment, a data segment, and a device segment.

6. The method of claim 1, wherein the window comprises a slider for selecting a date range for troubleshooting.

7. The method of claim 5, wherein the coverage segment displays diagnostic results for one of the following coverage area issues: coverage, band compatibility, low coverage, lack of coverage, and roaming.

8. The method of claim 5, wherein the voice segment displays diagnostic results for one of the following voice issues; dropped calls and WiFi dropped calls.

9. The method of claim 5, wherein the data segment displays diagnostic results for one of the following data issues: delay, data leakage, and domain name server impairment.

10. The method of claim 5, wherein the device segment displays diagnostic results for one of the following device issues: device compatibility and device software.

11. A computer-implemented method of troubleshooting customer issues in a network, the method, comprising:
displaying a window containing diagnostic segments in a format within a graphical user interface on a computer screen;
monitoring the window to detect a selection of a diagnostic segment;
automatically displaying a diagnostic result for the selected diagnostic segment; and
automatically displaying the one recommendation or explanation in a recommendation segment of the window.

12. The method of claim 11, wherein the recommendation or explanation is one of: a recommendation to update a device, a recommendation to update software running on the device, or information about an access point service disruption.

13. A non-transitory computer storage media storing computer-usable instructions that, when used by one or more processors, cause the processor to:
display a window containing diagnostic segments in a format within a graphical user interface on a computer screen;
monitor the window to detect a selection of a diagnostic segment;
display automatically a diagnostic result for the selected diagnostic segment; and
display automatically on an event timeline window segment information on a network service degradation event.

14. The non-transitory computer storage media of claim 13, wherein the window comprises a recommendation segment.

15. The non-transitory computer storage media of claim 13, wherein the window comprises a customer information segment.

16. The non-transitory computer storage media of claim 13, wherein the diagnostic segment is selected from: a coverage segment, a voice segment, a data segment, and a device segment.

17. The non-transitory computer storage media of claim 16, wherein the coverage segment displays diagnostic results for one of the following coverage area issues: coverage at night, band compatibility, low coverage, lack of coverage, and domestic roaming.

18. The non-transitory computer storage media of claim 16, wherein the voice segment displays diagnostic results for one of the following voice issues: dropped calls and WiFi dropped calls.

19. The non-transitory computer storage media of claim 16, wherein the data segment displays diagnostic results for one of the following data issues: delay, data leakage, and domain name system impairment.

20. The non-transitory computer storage media of claim 16, wherein the device segment displays diagnostic results for one of the following device issues: device compatibility and device software.
